(19) United States
(12) Patent Application Publication
(10) Pub. No.: US 2012/0216547 A1
(43) Pub. Date: Aug. 30, 2012

(54) POWER PLANT FOR CO2 CAPTURE

(75) Inventors: Hongtao LI, Aarau (CH); Holger Gerhard Nagel, Stuttgart (DE); Celine Mahieux, Baden (CH); Francois Droux, Oberrohrdorf (CH)

(73) Assignee: ALSTOM Technology Ltd, Baden (CH)

(21) Appl. No.: 13/434,029

(22) Filed: Mar. 29, 2012

Related U.S. Application Data
(63) Continuation of application No. PCT/EP2010/063848, filed on Sep. 21, 2010.

(30) Foreign Application Priority Data
Sep. 29, 2009 (EP) 09171635.7

(51) Int. Cl. F01N 3/00; F02C 3/00; F01D 1/00; F02C 3/34

(52) U.S. Cl. 60/772; 60/39.5; 60/643; 60/645

(57) ABSTRACT

An exemplary fossil fuel fired power plant is disclosed with minimum impact of the CO2 capture system on a power part of the plant. A power plant is disclosed which is ready for the retrofit of a CO2 capture plant, and a method is disclosed for retrofitting an existing plant into a power plant with CO2 capture. A power plant part is disclosed which can provide steam and power to operate CO2 capture system, and provide a CO2 capture system, which has the capacity to remove CO2 from flue gas flow of the power part, and of the additional power plant part.

### RELATED APPLICATION(S)

This application claims priority as a continuation application under 35 U.S.C. §120 to PCT/EP2010/063848, which was filed as an International Application on Sep. 21, 2010 designating the U.S., and which claims priority to European Application 09171635.7 filed in Europe on Sep. 29, 2009. The entire contents of these applications are hereby incorporated by reference in their entireties.

### FIELD

The disclosure relates to power plants with integrated CO2 capture as well as CO2 capture ready power plants.

### BACKGROUND INFORMATION

Generation of greenhouse gases can lead to global warming and further increases in greenhouse gas production will further accelerate global warming. Because CO2 (carbon dioxide) is identified as a greenhouse gas, carbon capture and storage is considered one potential means to reduce the release of greenhouse gases into the atmosphere and to control global warming. In this context CCS can be defined as the process of CO2 capture, compression, transport and storage. Capture is defined as a process in which CO2 can be removed either from flue gases after combustion of a carbon based fuel or the removal of and processing of carbon before combustion. Regeneration of any absorbents, adsorbents or other means to remove CO2 from a flue gas or fuel gas flow can be considered to be part of the capture process.

CO2 capture technology currently considered closest to large-scale industrial application is post-combustion capture. In post-combustion capture the CO2 can be removed from a flue gas. The remaining flue gas can be released to the atmosphere and the CO2 can be compressed for transportation and storage. There are several technologies known to remove CO2 from a flue gas, for example, absorption, adsorption, membrane separation, and cryogenic separation.

Known technologies for CO2 capture and compression can require relatively large amounts of energy. Publications on the optimization of different processes and reduction of the power and efficiency penalty by integrating these processes into a power plant are described below

EP 1688173 gives an example for post combustion capture and a method for the reduction of power output penalties due to CO2 absorption and the regeneration of the absorption liquid. Here it is proposed to extract steam for regeneration of the absorbent from different stages of the steam turbine of a power plant to minimize reduction in turbine output.

In the same context, the WO 2007/073201 suggests to use the compression heat, which results from compressing the CO2 flow, for regeneration of the absorbent.

The use of cryogenic CO2 separation using a swirl nozzle and efforts to optimize this method's integration into a power plant process are described in U.S. Patent Application Publication No. 2009/0173073.

These methods address the power requirements of specific CO2 capture equipments. However they can increase the complexity of the plant and plant operation. Further, complex integrated solutions can render it difficult to retrofit CO2 capture equipment into an existing power plant or power plant concept.

### SUMMARY

A power plant is disclosed comprising a power part; a CO2 power part; a flue gas system for mixing flue gas flow paths of the power part and the CO2 power part into a mixed flue gas mass flow path; and a CO2 capture system for removing CO2 from mixed flue gas, wherein the power part is a fossil fuel fired steam power plant or a gas turbine based power plant, and wherein the CO2 power part is a fossil fuel fired steam power plant or a gas turbine based power plant for providing at least thermal and/or electrical power to capture CO2 from the mixed flue gas mass flow path.

A capture ready power plant is disclosed, comprising: a power part; space for a CO2 capture plant, including a CO2 power part; and a flue gas system for mixing a flue gas flow path of the power part and a flue gas flow path of the CO2 power part, and a CO2 capture system for removing CO2 from a mixed flue gas mass flow path; wherein the power part is a fossil fuel fired steam power plant or a gas turbine based power plant, and wherein the CO2 power part is a fossil fuel fired steam power plant or a gas turbine based power plant, for providing at least thermal and/or electrical power to capture CO2 from the mixed flue gas mass flow path.

A method is disclosed for retrofitting an existing fossil fuel fired power plant without CO2 capture to a power plant with CO2 capture is disclosed, comprising: building a CO2 power part, flue gas ducting, and a CO2 capture system near an existing power part; capturing, via an arrangement of the CO2 capture system, CO2 from flue gases of the power part and flue gases of the CO2 power part which have been mixed; and providing via an arrangement of the CO2 power part, at least electrical and/or thermal energy to capture CO2 from a mixed flue gas mass flow.

A method for operating a power plant is disclosed mixing flue gas flow paths of a power part and a CO2 power part via a flue gas system into a mixed flue gas; removing via a CO2 capture system, CO2 from the mixed flue gas, wherein the power part is a fossil fuel fired steam power plant or a gas turbine based power plant, and wherein the CO2 power part is a fossil fuel fired steam power plant or a gas turbine based power plant for providing at least thermal and/or electrical power to capture CO2 from a mixed flue gas mass flow path; and starting, loading and deloading the power part, the CO2 power part, and the CO2 capture system in response to control parameters to optimize overall power plant operation.

### BRIEF DESCRIPTION OF THE DRAWINGS

The disclosure shall be described in more detail below with the aid of the accompanying drawings. Referring to the drawings:

FIG. 1 schematically shows a power plant including a fossil fuel fired steam power part with a fossil fuel fired steam power plant as a CO2 power part and a CO2 capture system according to an exemplary embodiment of the disclosure;

FIG. 2 schematically shows a power plant including a fossil fuel fired steam power part with a gas turbine combined cycle plant as a CO2 power part and a CO2 capture system according to an exemplary embodiment of the disclosure;

FIG. 3 schematically shows a fossil fuel fired steam power part with a gas turbine combined cycle plant with flue gas recirculation as a CO2 power part and a CO2 capture system according to an exemplary embodiment of the disclosure;

FIG. 4 schematically shows a power plant including a combined cycle power plant as a power part with a gas turbine combined cycle plant with flue gas recirculation as a CO2 power part and a CO2 capture system according to an exemplary embodiment of the disclosure;

FIG. 5 schematically shows a power plant including a power part with a CO2 power part in which both plant parts are combined cycle power plants with flue gas recirculation and a CO2 capture system according to an exemplary embodiment of the disclosure;

FIG. 6 schematically shows a power plant including a fossil fuel fired steam power part with a gas turbine combined cycle plant with flue gas recirculation as a CO2 power part in which the low-pressure steam turbine can be decoupled by a clutch during CO2 capture operation and a CO2 capture system according to an exemplary embodiment of the disclosure; and

FIG. 7 schematically shows the achievable CO2 capture rate as a function of the available specific energy to capture CO2 for different CO2 concentrations of the flue gas.

### DETAILED DESCRIPTION

The present disclosure provides a fossil fuel fired power plant with minimum impact of the CO2 capture system (also called CO2 capture plant) on the plant as well as a method to operate such a plant. Further, a power plant, which is ready for the retrofit of a CO2 capture plant and a method to retrofit an existing plant into a power plant with CO2 capture as well as a method to operate this kind of plant.

According to an exemplary embodiment of the disclosure, a plant can include at least two parts. A plant including at least one part, which is basically designed like a known power plant without CO2 capture, at least one additional fossil fuel fired power plant part, plus at least one CO2 capture system designed to capture CO2 from the flue gases of the plant part and of the additional CO2 power plant part. The known part of the power plant is called the power part. The additional power plant part is called CO2 power part.

An exemplary embodiment of the disclosure provides a CO2 power part, which can provide the steam and power required to operate the CO2 capture system, and to provide a CO2 capture system, which can remove CO2 from the flue gas flows of the power part, and of the CO2 power part. Due to the capability of the CO2 power part to drive the overall CO2 capture system, the plant can be optimized disregarding the requirements of the CO2 capture system. In particular no steam extraction is required from the steam turbine or any other part of the steam cycle of the power part. Further, the mechanical, electrical, and control interfaces between the power part and the CO2 power part can be kept at a minimum. The mechanical interface can be limited to the flue gas ducts. The control interface can be limited to a simple load signal.

Depending on the grid requirements and permits, the CO2 power part can be designed to match the CO2 capture system's power requirements or can be sized larger in order to increase the total plants net output compared to that of the power part itself.

The CO2 power part itself can be optimized for a process in which a large portion or all of the steam can be extracted for the CO2 capture system.

The separation of the power part and the CO2 power part can allow the independent operation of the power part with or without CO2 capture under optimal conditions, which are else needed to facilitate CO2 capture. Further, the impact of CO2 capture on the overall plant capacity can be minimized. Depending on the operating permits and grid requirements, the electric power, which can be delivered to the power grid should not be changed if CO2 capture equipment comes into operation or CO2 capture equipment is added to an existing plant.

In a known power plant with CO2 capture, the power plant capacity can be reduced once CO2 capture equipment comes into operation. Even when CO2 capture equipment is not in operation, the efficiency of the steam cycle can be compromised by providing the possibility to extract steam for a possible CO2 capture.

According to exemplary embodiment of the disclosure, the power part and the CO2 power part can be a fossil fuel fired steam power plant or a gas turbine based power plant. A gas turbine based power plant can be, for example, a combined cycle power plant, a simple cycle gas turbine power plant, or a gas turbine with co-generation or any combination of these plant types. If applicable, the CO2 power part can be sized to provide steam needed for regeneration of a CO2 absorbent or a CO2 adsorbent. Its steam cycle can be optimized to provide steam for regeneration of a CO2 absorbent or CO2 adsorbent without compromising the power part. The CO2 power part can be sized to provide at least the auxiliary power needed to operate the CO2 capture equipment. Further it can be sized to also provide the power needed for CO2 compression.

By providing not only CO2 capture equipment but a CO2 power part with a CO2 capture system, drawbacks, such as an efficiency penalty on the power part and capacity reduction can be avoided.

In an exemplary embodiment of the disclosure, a plant can be provided in which the flue gases of the power part are mixed with the flue gases of the CO2 capture part before the CO2 is captured from the mixture of flue gas flows.

Mixing of the flue gas flows can be advantageous because only one CO2 capture part is required. This facilitates operation of the overall plant and can reduce the initial investment as well as the operation cost of the plant. Further, depending on the CO2 concentration of the two flue gas flows, the CO2 capture rate and type of capture plant, the energy requirement to capture the CO2 from the mixed flue gas can be lower than the energy requirement to capture CO2 from two separate flue gas flows. This can be true if the power part has a first CO2 concentration in the flue gases, and the CO2 capture part has a second CO2 concentration in the flue gases, which is different from the first CO2 concentration. The mixture has a mass averaged flue gas concentration, which is above the lower CO2 concentration and can lead to a better capture performance of the overall system.

In an exemplary embodiment according to the disclosure, the power part can be a fossil fuel fired steam power plant, for example, a power plant including at least one fossil fuel fired boiler with at least one steam turbine, and the CO2 power part can include a combined cycle power plant.

The CO2 concentration of the fossil fuel fired steam power plant can be in the order of about 9 to 12% (mole), and can reach even higher values. Depending on the gas turbine type and on the operating conditions, the CO2 concentration in the flue gases of a gas turbine can be in the order of 2 to 5% (mole). At low load the CO2 concentration in the flue gases of a gas turbine can even be as low as 1 to 2% (mole). These low CO2 concentrations do not allow an efficient CO2 removal from the flue gases.

By mixing flue gas from the fossil fuel fired power part with flue gases from the gas turbine, the overall CO2 concentration can remain at a sufficiently high level to allow efficient CO2 removal at a high removal rate.

Recirculation of part of a gas turbines flue gases into the inlet air of the gas turbine to increase the CO2 concentration of the flue gases has been proposed in the past. However, this can require additional ducts, flue gas coolers and other equipment and therefore can increase space requirements and complexity of the plant. Further, depending on the gas turbine type and fuel used, the recirculation ratio can be limited to less than about 50% of the gas turbine's flue gases so that even with flue gas recirculation the CO2 concentration in the flue gases can stay below the level of a fossil fuel fired steam power plant.

Therefore an exemplary embodiment in which the power part is a fossil fuel fired steam power plant, and the CO2 power part includes a combined cycle power plant with flue gas recirculation is disclosed. In this embodiment the additional equipment, space and operational effort to increase the CO2 concentration of the gas turbine's flue gases by recirculation can be made. The gas turbine's flue gases can be mixed with the flue gases of the fossil fired steam power plant, resulting in a high CO2 concentration for relatively efficient CO2 removal.

In an exemplary embodiment according to the disclosure for CO2 capture from a combined cycle power plant, the CO2 power part can be based on a fossil fuel fired steam plant. Mixing of the fossil fuel fired CO2 capture part's flue gases with the flue gases of the combined cycle power plant can increase the CO2 concentration of the flue gases compared to those of the combined cycle power plant, leading to a better CO2 capture efficiency. This can be done for combined cycle power plants with and without flue gas recirculation.

Further, both the power part and the CO2 power part can be combined cycle power plants. In this case mixing of both flue gas flows allows the use of only one CO2 capture plant, thus reducing the amount of equipment needed and simplifying the overall plant layout.

In an exemplary embodiment according to the disclosure, a combined cycle power plant can be combined with a CO2 capture part based on a combined cycle power plant with recirculation. This can allow existing gas turbine technology for the power part to be combined with up to date technology on the CO2 capture part side. The CO2 concentration of the power part's flue gases can be increased by mixing with the flue gases from the CO2 capture part, thus facilitating CO2 capture.

This combination can be suitable for retrofit applications into existing combined cycle power plants. Due to operational constraints or site-specific limitations in the plant arrangement, recirculation of flue gases might not be feasible for an existing combined cycle power plant. However, the additional CO2 capture parts combined cycle can be based on a new gas turbine designed for recirculation and the plant arrangement can be designed with the space required for CO2 capture and recirculation. Again, the mixed flue gases can have a higher CO2 concentration than the flue gases of the combined cycle power plant without recirculation.

In an exemplary embodiment according to the disclosure, the power part and the CO2 power part can both include a combined cycle power plant with recirculation. This can give the advantage of only using one CO2 capture system for both plant parts. Further, it is possible to apply two different recirculation rates. The recirculation rate of gas turbines can be limited to a low fraction of the flue gases and the resulting CO2 concentration of the flue gases can still be moderate. It can remain below about 6% (i.e., ±10%) without any design modifications to allow high recirculation rates.

The recirculation rate of gas turbines designed for flue gas recirculation, can allow the recirculation of a higher fraction of the flue gases leading to a high CO2 concentration in the flue gases. This kind of gas turbine can be employed for the CO2 power part, especially in the case of retrofit applications. By mixing both flue gas flows the average CO2 concentration can allow an efficient CO2 capture from the total flue gas flow.

An exemplary embodiment of the disclosure relates to a power plant burning a carbon-based fuel, which is prepared for the addition or retrofit of a CO2 capture plant. This type of plant is also called capture ready. A distinguishing feature of this capture ready plant is that the plant arrangement is not designed to simply provide space required for a future CO2 capture system but that it is designed for a complete CO2 capture plant, i.e. a future CO2 capture system plus a future CO2 power part to drive the CO2 capture system. Further, space for a flue gas system that mixes the flue gas flows of the power part and the CO2 power part is provided.

In an exemplary embodiment according to the disclosure, the stack of the capture ready plant can already be designed for the maximum flue gas flow of the final plant including the power part and the CO2 power part. Further, the stack can be arranged at its final location considering the CO2 power part. The power part and the future CO2 power part can be arranged to discharge their flue gases next to each other to minimize the flue gas ducting. Further, the flue gas ducts can already include a flap, damper or diverter to direct the flue gases to the CO2 capture system, once it is retrofitted. This allows the normal operation of the power part during construction of the CO2 power part. The CO2 power part can be commissioned independently of the operation of the power part and the CO2 capture system itself can be tested and commissioned up to part of its capacity using the flue gases of the CO2 power part. For change over to CO2 capture from the power part, the direction into which the flap, damper or diverter releases its flue gases simply has to be changed. Once the CO2 capture plant is in full operation, the part of the original flue gas duct of the power part, which is downstream of the damper or diverter can become a bypass duct. To allow the future use as a bypass stack, the stack of the retrofit ready power plant is designed with the flow capacity, which is required to bypass the mixed flue gases of the power part, and the future CO2 power part around the future CO2 capture system.

To take the additional pressure losses of the CO2 capture system into account, space for a flue gas blower can be provided. This can allow optimizing the power part for the initial back pressure of the ducting, which is directly leading the flue gases to the stack. In an exemplary embodiment according to the disclosure, the flue gas blower can be installed downstream of the diverter or damper and is only needed for CO2 capture operation.

Besides this single mechanical interface, control interfaces between the power part, the CO2 power part and the CO2 capture system may be required. Further, a common electrical system and grid connection is advantageous.

An advantage of the plant arrangement is the possibility to retrofit or upgrade an existing fossil fired power plant without CO2 capture to a power plant with CO2 capture without any significant modifications to the existing power plant. One element of an exemplary embodiment according to the disclosure is a method of retrofitting an existing fossil fuel fired power plant without CO2 capture to a power plant with CO2 capture. According to this method a CO2 power part, flue gas ducting and CO2 capture system can be built next to the existing power plant. The flue gas ducting can be designed to mix the flue gases of the existing power part and the CO2 power part, wherein the CO2 capture system can be designed to capture CO2 from the mixed flue gases. The CO2 power part is designed to provide at least the thermal and/or electrical energy required to capture CO2 from the mixed flue gases.

According to an exemplary embodiment according to the disclosure, in this method, the CO2 capture system, the flue gas ducting, and the CO2 power part can be built while the power plant is in normal operation and operation of the existing fossil fuel fired power plant is only interrupted for connecting the existing fossil fuel fired power plant to the additional or changed flue gas ducting and subsequent recommissioning. Depending on the existing plant's stack and, the change in total flue gas flow, a new stack might be required. The stack or stack modification can be considered to be part of the flue gas ducting.

Interruption of the commercial operation of the existing power plant can thus be minimized. The time needed for reconnecting or changing the flue gas ducts can be reduced below the time needed for a normal scheduled maintenance outage. The CO2 power part can be commissioned parallel to commercial operation of the existing plant. Further, the main commissioning effort of the CO2 capture system can be carried out while the system is using flue gasses from the CO2 power part.

An exemplary embodiment according to the disclosure relates to methods to operate a thermal power plant for the combustion of carbon-based fuels with a CO2 capture system as described above.

Exemplary embodiments of power plants described above allow a flexible operation with CO2 capture and different operating methods depending on the optimization target. Possible optimization targets can be, for example, maximum power, maximum efficiency, and maximum CO2 capture rate.

In particular the order in which the power part, the CO2 power part and CO2 capture system are started, loaded and deloaded can be used as control parameter to optimize the plant operation.

For example, if the power part is a steam power plant, its start up can take a relatively long time, for example, several hours. During the start-up, the flue gas composition and temperature may not be optimized for CO2 capture. However, the total CO2 emitted during this period of time can be small compared to the CO2 emitted during a typical operating period. CO2 capture can commence only after the power part is loaded to a high part load or base load. If the CO2 power part is a gas turbine based power plant, which can start-up and load considerably faster, it is started with a time delay matched to the difference in time between start-up and loading of the power part and start-up and loading of the CO2 power part.

Further, the CO2 capture system will be started and loaded after the CO2 power part delivers sufficient power to operate it.

Depending on the CO2 capture system used, the start up of the CO2 capture system can take place in a matter of minutes, for example for CO2 separation using swirl nozzles which are driven by electric motors. However, for some CO2 capture systems, for example, absorption or adsorption systems, the start up can take longer periods of time in the order of one or several hours. The start-up time of the CO2 capture system should be considered during start-up of the overall plant. If needed, the CO2 power part can be started earlier to take into account the CO2 capture systems start-up time. Depending on the different plant start-up times the CO2 power part can be started before the power part in order to assure CO2 capture, once it is required.

To allow fast loading of the power plant according to the requirements of the electricity grid or dispatcher, there is a method according to an exemplary embodiment of the disclosure in which a change in net power output of the plant can be achieved by first loading the power part and CO2 power part to meet the target net power output and the CO2 capture system can come into operation and the capture rate can be increased to reach the target capture rate. While the CO2 capture system runs up and/or is increasing, the capture rate and the net power output is kept constant and the gross power output of the plant is further increased to meet the increasing power consumption of the CO2 capture system.

To simplify the control interfaces between the power part and the CO2 power part, two separate power control methods can be used.

The load of CO2 power part can be controlled as a function of the CO2 capture systems main operating parameters, for example, the CO2 capture systems' power demand, the total mixed flue gas mass flow, the CO2 content of the mixed flue gas flow, or a combination of these parameters or another parameter representing the capture system's operating condition.

The load control of the power part can be used to control the net power output of the power plant. The power part and CO2 power part can have one common connection to the grid. The total power delivered to the grid via this grid connection is the net power and can meet the grid's power demand. According to an exemplary embodiment according to the disclosure, the power part can be controlled to deliver the difference in power between the grid's power demand and any excess net power output of the CO2 power part, which it delivers besides driving the CO2 capture system.

Fossil fuel fired steam power plants as described here can be coal fired steam power plants. However, the disclosure is also applicable to any other kind of fossil fuel fired steam power plants such as, for example, oil or gas fired steam power plants.

Components of the power plant with CO2 capture according to this disclosure are a power part 1, a CO2 power part 2, and a CO2 capture system 12.

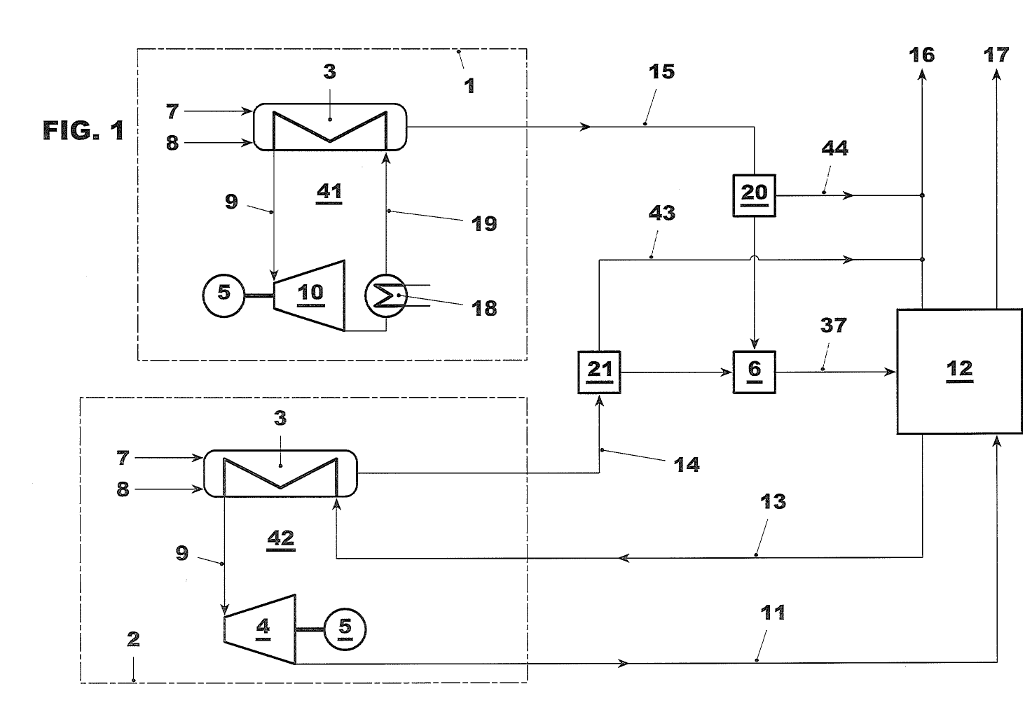

A first example of a plant arrangement according to an exemplary embodiment of the disclosure is shown in FIG. 1. In this example the power part 1 is a fossil fuel fired steam power plant 41. It includes a boiler 3 to which fossil fuel 8 and air 7 are supplied. The fuel 7 and air 8 are combusted generating live steam 9 and power part flue gases 15. Further, it can include a steam turbine 10, which is driven by the live steam 9, a generator 5, which produces electric power, and a condenser 18 from which feed water 19 is returned to the boiler. The steam cycle is simplified and shown schematically without different steam pressure levels, feed water pumps, etc.

In an exemplary embodiment according to the disclosure, the CO2 power part 2 can be a fossil fuel fired back pressure steam power plant 42. It can include a boiler 3 to which fuel 8 and air 7 are supplied. The fuel 7 and air 8 are combusted generating live steam 9 and CO2 power part flue gases 14. Further, it can include a back pressure steam turbine 4, which is driven by the live steam 9, and a generator 5, which produces electric power. The low-pressure steam 11 leaving the back pressure steam turbine 4 is supplied via a steam line to the CO2 capture system 12. Condensate 13 is returned to the boiler 3 from the CO2 capture system 12. This steam cycle is also simplified and shown schematically without different steam pressure levels, feed water pumps, etc.

The CO2 capture system 12 is schematically shown as a box which removes CO2 from a mixed flue gas 37, which includes power part flue gases 15 and CO2 power part flue gases 14. The CO2 depleted flue gas 16 is released from the CO2 capture unit to a stack 16. In case the CO2 capture unit 12 is not operating, it can be bypassed via the flue gas bypasses. To control the bypasses, a bypass flap for the flue gases of power part 20 and a bypass flap for the CO2 power part 21 can be provided in the flue gas ducting.

A CO2 capture system 12 according to an exemplary embodiment of the disclosure can include, for example, a CO2 absorption unit, in which CO2 is removed from the mixed flue gas 37 by an absorbent, and a regeneration unit, in which the CO2 is released from the absorbent. Depending on the temperature of the flue gas and the operating temperature range of the CO2 absorption unit a flue gas cooler 6 can also be required. The captured CO2 can be sent for compression and storage 17.

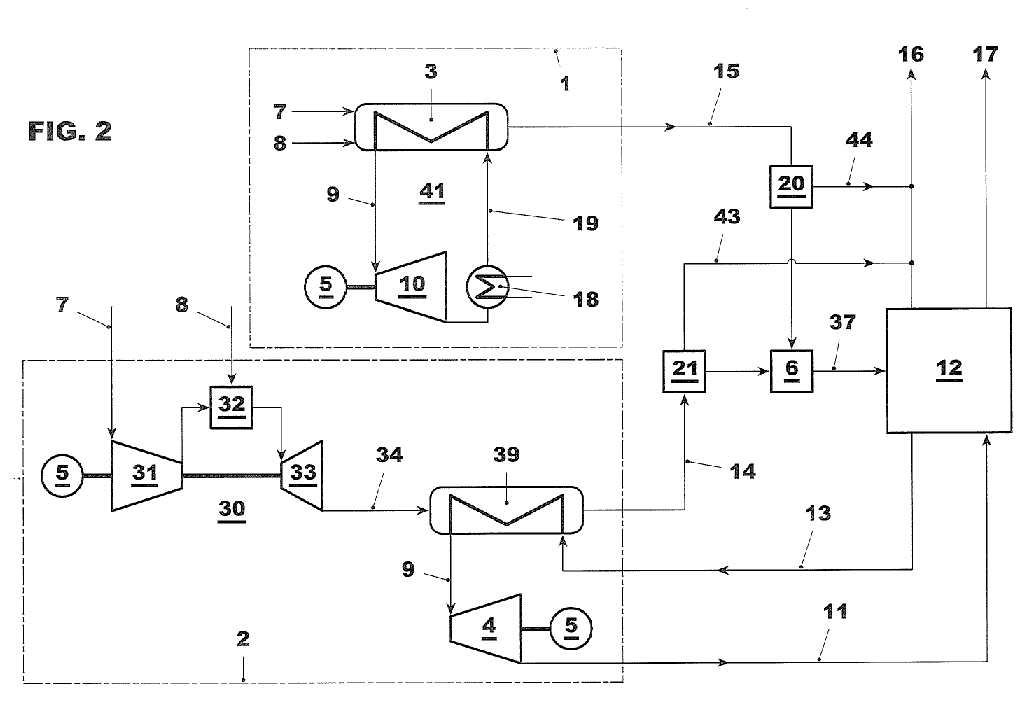

FIG. 2 schematically shows a power plant including a fossil fuel fired steam power plant 41, a combined cycle power plant 30, and a CO2 capture system 12. The steam power plant 41, and the CO2 capture system 12, are analogous to those shown in FIG. 1.

The combined cycle power plant 30 includes a gas turbine, and a heat recovery steam generator 39 with a water steam cycle. The gas turbine includes a compressor 31, in which inlet air 7 is compressed, a combustor 32, and a turbine 33 and drives a generator 5. The compressed gas can be used for combustion of the fuel 8 in the combustor 32, and the pressurized hot gases expand in the turbine 33. Its main outputs can be electric power from the generator 5, and hot flue gases 34. The hot flue gases 34 pass the heat recovery steam generator 39 (HRSG), which generates live steam 9. The flue gases leave the HRSG 39 at a lower temperature level and can be directed to the CO2 capture system 12 as flue gases of the CO2 power part 14. Further, the combined cycle power plant 30 can include a back pressure steam turbine 4, which is driven by the live steam 9, and a generator 5, which produces electric power. The low-pressure steam 11 can be supplied via a steam line to the CO2 capture system 12. Condensate 13 or low-grade steam can be returned to the boiler 3 from the CO2 capture system 12. This steam cycle is also simplified and shown schematically without different steam pressure levels, feed water pumps, etc.

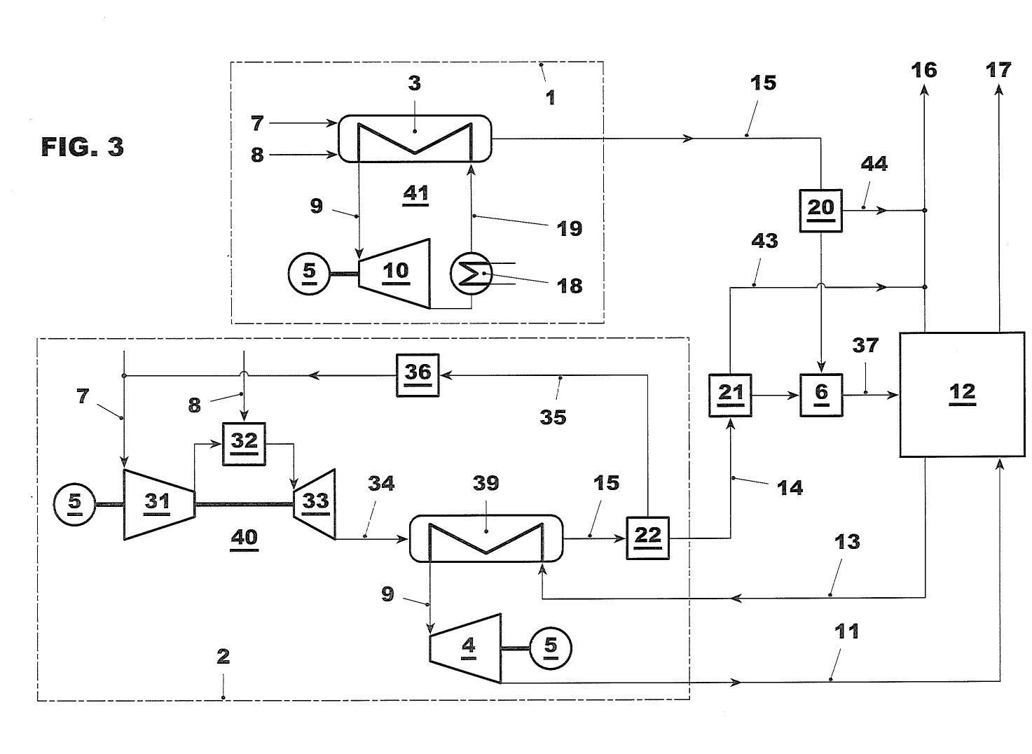

FIG. 3 schematically shows an exemplary embodiment of a power plant according to the disclosure of a fossil fuel fired steam power plant 41, a combined cycle power plant 40, and a CO2 capture system 12. The parts are analogous to those shown in FIG. 2. However, the gas turbine shown here can be a gas turbine with flue gas recirculation. A controllable fraction of the flue gases can be diverted in the control flap for flue gas recirculation 22 and recirculated to the inlet air 7 via the flue gas recirculation line 35. The recirculated flue gas can be cooled in the flue gas cooler 36 to limit or control the inlet temperature of the gas turbine compressor 31. The flue gas cooler 36 can include a condensate separator, which removes condensate from the cooled flue gases.

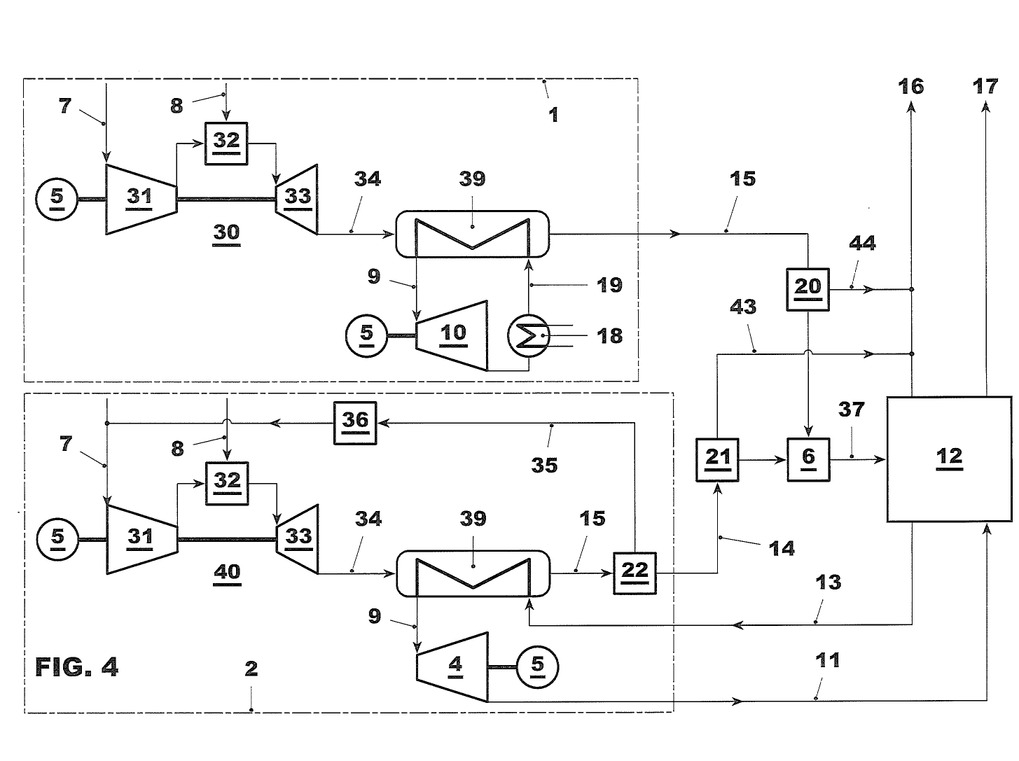

FIG. 4 schematically shows a power plant according to an exemplary embodiment of the disclosure, which includes a combined cycle power plant 30 as power part 1, a gas turbine combined cycle plant with flue gas recirculation 40 as CO2 power part 2, and a CO2 capture system 12. The arrangement is based on the one shown in FIG. 3. Instead of a steam power plant 41, a combined cycle power plant 30 can be used as the power part 1.

The combined cycle power plant 30 includes a gas turbine, a heat recovery steam generator 39 with a water steam cycle. The gas turbine includes a compressor 31, in which inlet air 7 can be compressed, a combustor 32, and a turbine 33, and drives a generator 5. The compressed gas can be used for combustion of the fuel 8 in the combustor 32, and the pressurized hot gases expand in the turbine 33. Its main outputs can be electric power from the generator 5, and hot flue gases 34. The hot flue gases 34 pass the heat recovery steam generator 39, which generates live steam 9. The flue gases leave the HRSG 39 at a lower temperature level and are directed to the CO2 capture system 12 as flue gases of the power part 15. Further, it can include a steam turbine 10, which is driven by the live steam 9, a generator 5, which produces electric power, and a condenser 18 from which feed water 19 is returned to the HRSG 39.

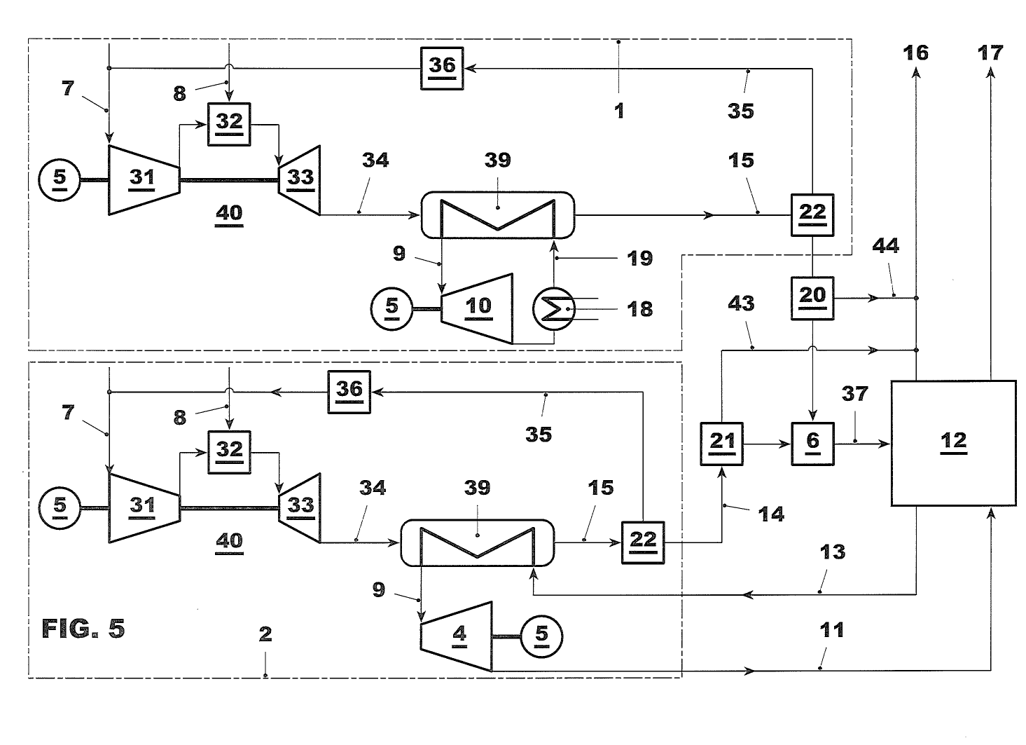

FIG. 5 schematically shows another example of a power plant according to an exemplary embodiment of the disclosure including two combined cycle power plants with flue gas recirculation 40 and a CO2 capture system 12. The parts are analogous to those shown in FIG. 4. However, the gas turbine of the power part 1 is also a gas turbine with flue gas recirculation. A controllable fraction of the flue gases can be diverted in the control flap for flue gas recirculation 22 and recirculated to the inlet air 7 via the flue gas recirculation line 35. The recirculated flue gas can be cooled in the flue gas cooler 36 to limit or control the inlet temperature of the gas turbine compressor 31. The flue gas cooler 36 can include a condensate separator, which removes condensate from the cooled flue gases.

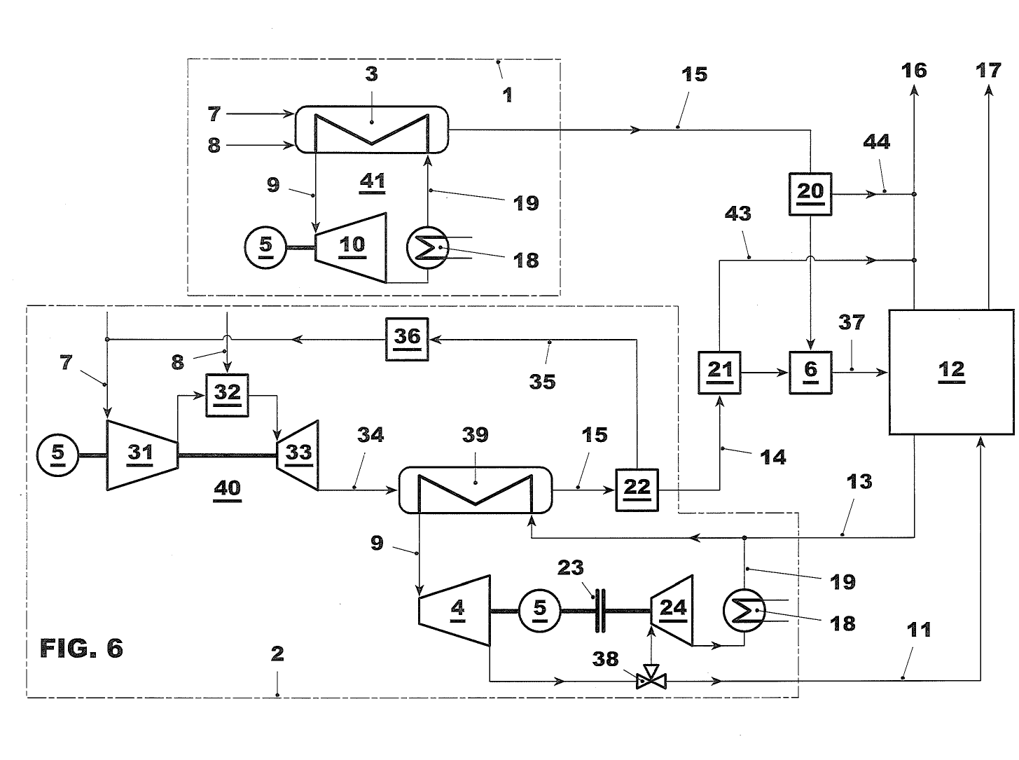

FIG. 6 is based on FIG. 3 and schematically shows a power plant according to an exemplary embodiment of the disclosure including a fossil fuel fired steam power plant 41, a combined cycle power plant 40 with flue gas recirculation, and a CO2 capture system 12. The steam power plant 41, and the CO2 capture system 12, are analogous to those shown in FIG. 3.

To increase the operational flexibility of the CO2 power part 2, the water steam cycle has been modified compared to the embodiment shown in FIG. 3. In this embodiment, an additional steam control valve 38, a low-pressure steam turbine 24, a condenser 18, and a feed water line 19 can be added to the water steam cycle. This arrangement can allow the use of low-pressure steam 11 to produce additional electric power in case that none, or not all, low-pressure steam 11 is required to operate the CO2 capture system 12. The split between low-pressure steam 11, which is directed to the CO2 capture system 12 and the low-pressure steam turbine 24 can be controlled by the steam control valve 38. The steam control valve 38 is schematically shown as a three-way valve. Alternatively other control means, such as for example two control valves, could also be used.

The steam turbine 24 can be mechanically connected to the generator 5 by a clutch 23. For example, an automatic overrunning clutch can be used to couple the low-pressure team turbine 24 to the existing shafting of the generator 5 and back pressure steam turbine 4. This arrangement can allow shutting down the low-pressure steam turbine 24 if the low-pressure steam is used for the CO2 capture system 12. Once excess low-pressure steam is available, the excess steam can be directed via the steam control valve 23 to the low-pressure steam turbine 24. It runs up, the clutch 23 automatically engages and the low-pressure steam turbine 24 can load up to drive the generator 5, and thus increase the electric power production of the plant.

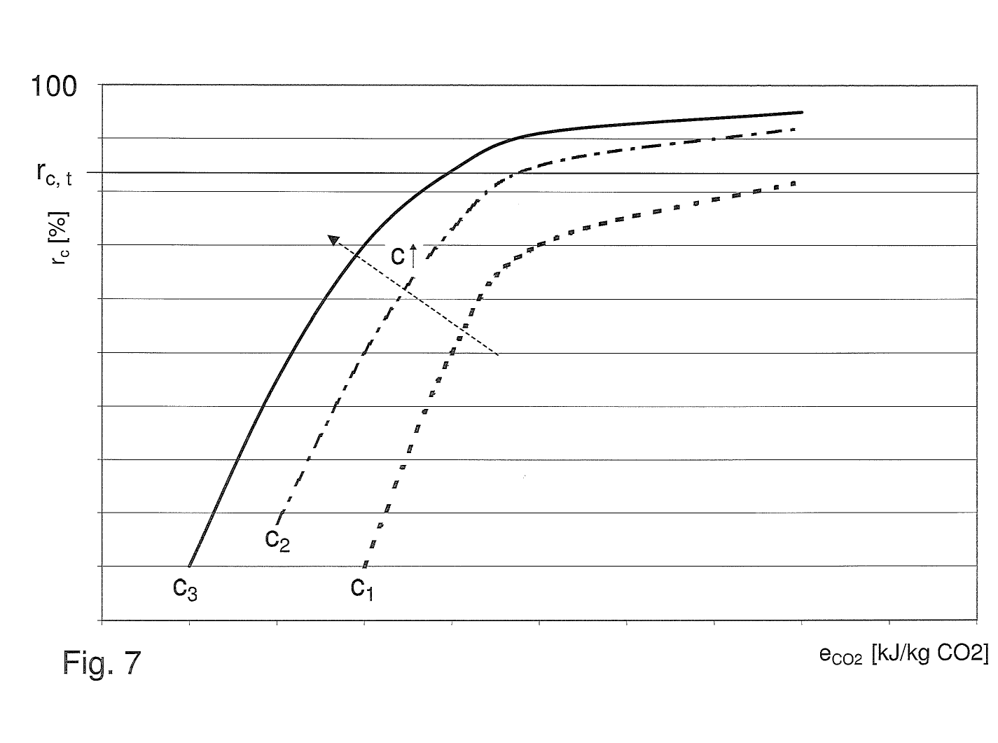

FIG. 7 schematically shows the achievable CO2 capture rate rc as a function of the available specific energy eCO2 to capture CO2 for different CO2 concentrations c1, c2 and c3 of the flue gas. The Figure visualizes the reason why it can be advantageous to mix two flue gas flows before CO2 capture.

With increasing CO2 concentration c↑ the capture rate rc, which can be achieved with a given specific energy eCO2 to capture CO2 from a flue gas, can increase. Further, the achievable capture rate rc, is proportional to the specific energy eCO2, which is available to capture CO2 from a flue gas. The achievable capture rate rc, shows a characteristic trend as function of the available specific energy eCO2 to capture CO2 for all concentrations c1, c2 and c3. Initially all curves show a step gradient, which becomes smaller and asymptotically approaches 100% capture rate rc. However, the capture rate rc at which the gradient changes depends on the CO2 concentration in the flue gases.

For a low CO2 concentration c1, a significant change in gradient occurs already at a relatively low capture rate rc. For a higher CO2 concentration c2 or c3, the favorable step gradient persists up to a high capture rate rc in the order of 90% or more. Due to the different capture rate, at which the change in gradient occurs, the specific energy eCO2 to reach a high capture rate order of 90% increases exponentially with lower CO2 concentrations in the flue gas as, for example, for the concentration c1. In consequence, the required energy to reach a specific target capture rate rc, t of, for example, 83% is lower, if a first flue gas flow with a low CO2 concentration c1 and a second flue gas flow with a high CO2 concentration c3 are mixed to obtain a mixed flue gas 37 with an average CO2 concentration c2 than if the CO2 is captured from the two separate flue gas flows.

Exemplary embodiments described above and in the drawings disclose to a person skilled in the art embodiments, which differ from the exemplary embodiments and which are contained in the scope of the disclosure.

For example, the low-pressure steam turbine 24 can be arranged on a separate shafting to drive a separate generator for electric power production or the steam turbine and gas turbine of any of the combined cycle power plants can be in single shaft arrangement.

As another example the CO2 power part, flue gases 14 and the power part flue gases 15 can be mixed upstream of a bypass flap 20, 21 so that only one bypass flap for the total flue gas is required. Further, arrangement of two flue gas coolers 6, one for the power part flue gases 15, and one for the CO2 power part flue gases 14, can be advantageous. This would for example be the case if the temperatures of the power part flue gases 15 and the CO2 power part flue gases 14 differ.

In the examples given above, single combustion gas turbines are described. It is to be understood that sequential combustion gas turbines, also called gas turbine with reheat combustor, as described for example in U.S. Pat. No. 5,577,378, can equally be used. A combination of sequential combustion gas turbine and singe combustion gas turbine based power plants can also be used. The application of sequential combustion gas turbines can be advantageous, as the CO2 concentration in their flue gases can be higher that in single combustion gas turbines. Further, any of the above examples can be realized with gas turbines with or without flue gas recirculation.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Power part

2 CO2 power part

3 Boiler

4 Back pressure steam turbine

5 Generator

6 Flue gas cooler

7 Air

8 Fuel

9 Live steam

10 Steam turbine

11 Low-pressure steam

12 CO2 capture system

13 Condensate or low grade return steam

14 CO2 power part flue gases

15 Power part flue gases

16 CO2 depleted flue gas

17 CO2 for compression and storage

18 Condenser

19 Feed water

20 Bypass flap for flue gases of the conventional power part

21 Bypass flap for flue gases of the CO2 power part

22 Control flap for flue gas recirculation

23 Clutch

24 Low-pressure steam turbine

30 Combined cycle power plant

31 Compressor

32 Combustor

33 Turbine

34 Gas turbine flue gas

35 Flue gas recirculation line

36 Flue gas cooler

37 Mixed flue gases

38 Steam control valve

39 HRSG

40 Combined cycle power plant with flue gas recirculation gas turbine

41 Steam power plant

42 Back pressure steam power plant

43 Bypass duct from conventional part

44 Bypass duct from CO2 power part

c↑ increase in concentration

c1, c2, c3 CO2 concentration in flue gas

rc capture rate

rc, t target capture rate

eCO2 specific energy required to capture CO2

What is claimed is:

1. A power plant comprising:
a power part;
a CO2 power part;
a flue gas system for mixing flue gas flow paths of the power part and the CO2 power part into a mixed flue gas mass flow path; and
a CO2 capture system for removing CO2 from mixed flue gas, wherein the power part is a fossil fuel fired steam power plant or a gas turbine based power plant, and wherein the CO2 power part is a fossil fuel fired steam power plant or a gas turbine based power plant for providing at least thermal and/or electrical power to capture CO2 from the mixed flue gas mass flow path.

2. A power plant according to claim 1, configured such that during operation, flue gas of the power part will have a first CO2 concentration, and flue gas of the CO2 power part will have a second CO2 concentration, which is different from the first CO2 concentration.

3. A power plant according to claim 1, wherein the power part is a fossil fuel fired steam power plant and the CO2 power part is a gas turbine power plant, or the power part is gas turbine based power plant and the CO2 power part is a fossil fired steam power plant.

4. A power plant according to claim 1, comprising:
a gas turbine based power plant with flue gas recirculation.

5. A power plant according to claim 1, wherein the power part and the CO2 power part are gas turbine based power plants, the gas turbine of the CO2 power part being configured for flue gas recirculation, and the power part being configured without flue gas recirculation or with a design recirculation rate which is lower than a design recirculation rate of the CO2 power part.

6. A power plant according to claim 1, wherein the CO2 power part is a combined cycle power plant, comprising:
at least one back pressure steam turbine for providing low or medium pressure steam to the CO2 capture system.

7. A power plant according to claim 6, wherein the back pressure steam turbine is sized to deliver a design steam flow of the CO2 capture system.

8. A capture ready power plant, comprising:
a power part;
space for a CO2 capture plant, including a CO2 power part; and
a flue gas system for mixing a flue gas flow path of the power part and a flue gas flow path of the CO2 power part, and a CO2 capture system for removing CO2 from a mixed flue gas mass flow path;
wherein the power part is a fossil fuel fired steam power plant or a gas turbine based power plant, and wherein the CO2 power part is a fossil fuel fired steam power plant or a gas turbine based power plant, for providing at least thermal and/or electrical power to capture CO2 from the mixed flue gas mass flow path.

9. A capture ready power plant according to claim 8, comprising:
a lay out designed such that flue gas flow paths of the power part and a future CO2 power part space are arranged to discharge flue gas next to each other, followed by space for mixing of the flue gases and by space for the CO2 capture system in order to minimize flue gas ducting.

10. A capture ready power plant according to claim 8, wherein the lay out comprises:
space for electrical power and steam supply lines from the CO2 power part to the CO2 capture system.

11. A capture ready power plant according to claim 10, wherein flue gas ducting comprises:
a mixing section for future connection of the CO2 power part;
a flue gas flap or damper with one closed branch prepared for connection to a future CO2 capture system and one branch leading to a stack, wherein the stack is designed with a flow capacity to bypass mixed flue gases of the power part and the future CO2 power part around the future CO2 capture system.

12. A method for retrofitting an existing fossil fuel fired power plant without CO2 capture to a power plant with CO2 capture, comprising:
building a CO2 power part, flue gas ducting, and a CO2 capture system near an existing power part;
capturing, via an arrangement of the CO2 capture system, CO2 from flue gases of the power part and flue gases of the CO2 power part which have been mixed; and
providing via an arrangement of the CO2 power part, at least electrical and/or thermal energy to capture CO2 from a mixed flue gas mass flow.

13. A method according to claim 12, comprising:
building the CO2 capture system, the flue gas ducting, and the CO2 power part while the power part is in operation;
interrupting operation of the existing fossil fuel fired power plant for connecting the existing power part to additional or changed flue gas ducting; and
recommissioning the existing fossil fuel fired power plant

14. A method for operating a power plant comprising:
mixing flue gas flow paths of a power part and a CO2 power part via a flue gas system into a mixed flue gas;
removing via a CO2 capture system, CO2 from the mixed flue gas, wherein the power part is a fossil fuel fired steam power plant or a gas turbine based power plant, and wherein the CO2 power part is a fossil fuel fired steam power plant or a gas turbine based power plant for providing at least thermal and/or electrical power to capture CO2 from a mixed flue gas mass flow path; and
starting, loading and deloading the power part, the CO2 power part, and the CO2 capture system in response to control parameters to optimize overall power plant operation.

15. A method according to claim 14, comprising:
starting the CO2 power part first;
starting the CO2 capture system second; and
starting the power part third in order to minimize CO2 emissions during start up and loading.

16. A method according to claim 14, for achieving a net power output of the plant during start up and loading, comprising:
first loading the power part, and CO2 power part;
starting and/or increasing the CO2 capture system's CO2 capture rate to reach a target capture rate after a target net power output is achieved; and
increasing a gross power output of the power plant while the CO2 capture system runs up and/or is increasing the capture rate.

17. A method according to claim 14, comprising, for steady state operation:
controlling a CO2 power part load as a function of total mixed flue gas mass flow, as a function of the CO2 content of the mixed flue gas flow, as a function of a power demand of the CO2 capture system or a combination of these parameters; and
using a load setting of the power part to control a net power output of the power plant.
